(19) United States
(12) Patent Application Publication
(10) Pub. No.: US 2026/0278921 A1
(43) Pub. Date: Sep. 17, 2026

(54) INFORMATION PROCESSING METHOD, INFORMATION PROCESSING DEVICE, AND PROGRAM

(71) Applicant: Sony Group Corporation, Tokyo (JP)

(72) Inventors: Kohei URUSHIDO, Kanagawa (JP); Takuto MOTOYAMA, Tokyo (JP); Eisuke NOMURA, Tokyo (JP)

(73) Assignee: Sony Group Corporation, Tokyo (JP)

(21) Appl. No.: 18/868,777

(22) PCT Filed: May 22, 2023
(86) PCT No.: PCT/JP2023/018872

§ 371 Date: Nov. 25, 2024

(30) Foreign Application Priority Data
Jun. 10, 2022 (JP) 2022-094131

(51) Int. Cl. G06T 17/00; G06T 7/20; G06T 7/70; G06V 20/17; H04N 23/60; H04N 23/61

(52) U.S. Cl. CPC G06T 17/00; G06T 7/20; G06T 7/70; G06V 20/17; H04N 23/61; H04N 23/64; G06V 2201/07

(57) ABSTRACT

There is provided an information processing method, an information processing device, and a program capable of generating a more accurate three-dimensional model. Based on sensing information acquired in a moving body, processing of detecting a defective subject that may degrade a performance of three-dimensional modeling of a subject of interest using images shot from a plurality of viewpoints is performed; and when the defective subject is detected, video shooting plan information for video shooting to reduce a region of the defective subject included in the shot images is output. The technology according to the present disclosure can be applied to, for example, a system that shoots shot images from a plurality of viewpoints to be used in three-dimensional modeling.

### TECHNICAL FIELD

The present disclosure relates to an information processing method, an information processing device, and a program, and more particularly to an information processing method, an information processing device, and a program capable of generating a more accurate three-dimensional model.

### BACKGROUND ART

PTL 1 discloses a moving body that, in a situation where there are a plurality of moving bodies such as drones each shooting a subject, controls its video shooting behavior based on, for example, the shooting ranges of the other moving bodies for shooting, so as to prevent the plurality of moving bodies from interfering with each other's shooting.

On the other hand, one method for achieving three-dimensional modeling of a real-world environment or a subject is to use images shot from a plurality of viewpoints. Specifically, the position and orientation of a moving body and the depth of a subject at the time of shooting can be estimated from the overlapping parts of images shot from a plurality of shooting points along the pathway of the moving body, thereby enabling three-dimensional reconstruction of the subject.

In this method, the video shooting plan, which determines what pathway to move and where to point the viewpoints to shoot images to be shot from the plurality of viewpoints, significantly affects the overall work efficiency and the accuracy of the generated three-dimensional model.

### CITATION LIST

### Patent Literature

PTL 1: JP 2021-166316 A

### SUMMARY

### Technical Problem

However, in the method of three-dimensional modeling using images shot from a plurality of viewpoints, if a subject that would degrade the performance of the three-dimensional modeling appears in a shot image, there is a risk that the accuracy of the final generated three-dimensional model will decrease. In particular, there is no known technology for video shooting in a way that avoids a subject that would degrade the performance of the three-dimensional modeling, without using the information about the shooting ranges of the other moving bodies, such as that disclosed in PTL 1, or information about the environment given in advance.

The present disclosure has been made in view of such circumstances, and makes it possible to generate a more accurate three-dimensional model.

### Solution to Problem

An information processing method of the present disclosure is an information processing method including: performing, based on sensing information acquired in a moving body, processing of detecting a defective subject that may degrade a performance of three-dimensional modeling of a subject of interest using images shot from a plurality of viewpoints; and outputting, when the defective subject is detected, video shooting plan information for video shooting to reduce a region of the defective subject included in the shot images.

An information processing device of the present disclosure is an information processing device including: a subject detection unit that performs, based on sensing information acquired in a moving body, processing of detecting a defective subject that may degrade a performance of three-dimensional modeling of a subject of interest using images shot from a plurality of viewpoints; and a video shooting planning unit that outputs, when the defective subject is detected, video shooting plan information for video shooting to reduce a region of the defective subject included in the shot images.

A program of the present disclosure is a program for causing a computer to execute processing of performing, based on sensing information acquired in a moving body, processing of detecting a defective subject that may degrade a performance of three-dimensional modeling of a subject of interest using images shot from a plurality of viewpoints; and outputting, when the defective subject is detected, video shooting plan information for video shooting to reduce a region of the defective subject included in the shot images.

In the present disclosure, based on sensing information acquired in a moving body, processing of detecting a defective subject that may degrade a performance of three-dimensional modeling of a subject of interest using images shot from a plurality of viewpoints is performed; and, when the defective subject is detected, video shooting plan information is output for shooting to reduce a region of the defective subject included in the shot images.

### BRIEF DESCIPTION OF DRAWINGS

FIG. 1 is a diagram illustrating three-dimensional modeling using images shot from a plurality of viewpoints.

FIG. 2 is a diagram illustrating a configuration example of a video shooting planning system to which the technology according to the present disclosure can be applied.

FIG. 3 is a block diagram illustrating a functional configuration example of the video shooting planning system.

FIG. 4 is a diagram illustrating correction of video shooting plan information.

FIG. 5 is a flowchart illustrating video shooting processing of a moving body.

FIG. 6 is a flowchart illustrating an operation of the video shooting planning system.

FIG. 7 is a block diagram illustrating another functional configuration example of the video shooting planning system.

FIG. 8 illustrates an example of a cost map.

FIG. 9 is a flowchart illustrating an operation of the video shooting planning system.

FIG. 10 is a block diagram illustrating still another functional configuration example of the video shooting planning system.

FIG. 11 is a block diagram illustrating still another functional configuration example of the video shooting planning system.

FIG. 12 is a diagram illustrating an overview of video shooting processing according to a first embodiment.

FIG. 13 is a diagram illustrating a change in the position and orientation of a moving body.

FIG. 14 is a diagram illustrating a change in the position and orientation of the

FIG. 15 is a flowchart illustrating video shooting processing of a moving body.

FIG. 16 is a diagram illustrating an overview of video shooting processing according to a second embodiment.

FIG. 17 is a diagram illustrating a change in the position and orientation of a moving body.

FIG. 18 is a diagram illustrating a change in the position and orientation of the moving body.

FIG. 19 is a diagram illustrating a change in the position and orientation of the moving body.

FIG. 20 is a flowchart illustrating video shooting processing of a moving body.

FIG. 21 is a diagram illustrating an overview of video shooting processing according to a third embodiment.

FIG. 22 is a flowchart illustrating video shooting processing of a moving body.

FIG. 23 is a diagram illustrating an overview of another video shooting processing according to the third embodiment.

FIG. 24 is a flowchart illustrating video shooting processing of a moving body.

FIG. 25 is a diagram illustrating an example of a defective subject according to a modification example.

FIG. 26 is a diagram illustrating a configuration example of a computer.

### DESCRIPTION OF EMBODIMENTS

Hereinafter, modes for carrying out the present disclosure (hereinafter referred as embodiments) will be described. The description will be made in the following order.
1. Conventional three-dimensional modeling method and its problem
2. Video shooting planning system according to present disclosure and its operation
2-2. Configuration with which three-dimensional modeling is performed after completion of video shooting
2-3. Configuration with which three-dimensional modeling is performed in parallel with video shooting
3. First embodiment (detection of defective subject by semantics estimation)
4. Second embodiment (detection of defective subject by optical flow estimation)
5. Third embodiment (detection of defective subject in dark place)
6. Modification examples
7. Configuration example of computer

### 1. Conventional Three-Dimensional Modeling Method and its Problem

In recent years, use cases for three-dimensional modeling of a real-world environment or a subject for purposes such as inspection, surveying, and content creation such as 3D assets for film production have expanded rapidly. Among various methods for implementing three-dimensional modeling itself, a simple and high performance method for implementing it is to use images shot from a plurality of viewpoints.

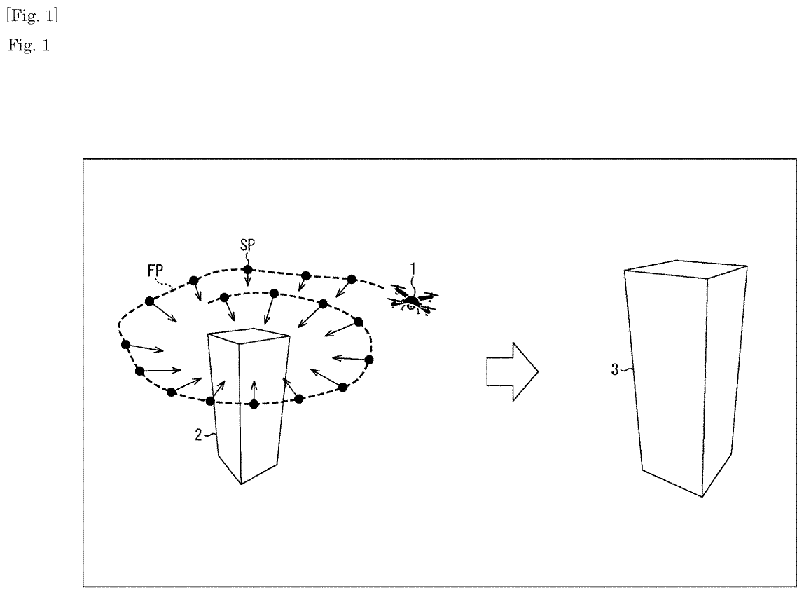

FIG. 1 is a diagram illustrating three-dimensional modeling using images shot from a plurality of viewpoints.

As illustrated in FIG. 1, the position and orientation of a moving body 1, which is a drone, and the depth of a subject 2 at the time of shooting can be estimated from the overlapping parts of images shot from a plurality of shooting points SP along a flight path FP of the moving body 1, thereby making it possible to generate a three-dimensional model 3 of the subject 2. The moving body 1 may shoot the subject 2 while completely stopped at each of the shooting points SP, or may shoot the subject 2 at each of the shooting points SP while moving along the flight path FP.

In this method, the video shooting plan, which determines what pathway to move and where to point the viewpoints to shoot images to be shot from the plurality of viewpoints, significantly affects the overall work efficiency and the accuracy of the generated three-dimensional model.

However, in the above-described method, since the depth of the subject is estimated based on the movement parallax of a single camera, when a moving object appears in most of the shot images, it is not possible to determine whether the camera or the subject is moving, which has a negative impact on three-dimensional modeling.

In addition, when an image in which an extremely bright subject, such as the sun, or a dark subject in a dark place, appears is used for three-dimensional modeling, the depth of the subject may be significantly misestimated, which may generate large-scale noise.

As described above, in the method of three-dimensional modeling using images shot from a plurality of viewpoints, if a subject that would degrade the performance of the three-dimensional modeling appears in a shot image, there is a risk that the accuracy of the final generated three-dimensional model will decrease.

Hitherto, there have been systems that propose video shooting plans based on the shape of a main subject to be subjected to the three-dimensional modeling, but there have been no systems that propose video shooting plans based on the texture of the main subject or the surrounding environment. If an image includes a subject that would degrade the performance of the three-dimensional modeling, it is necessary to manually remove that image and to input the remaining images into the three-dimensional modeling algorithm.

Therefore, a system to which the technology according to the present disclosure is applied can detect, when images are shot from a plurality of viewpoints to be used in the three-dimensional modeling, a subject that may degrade the performance of the three-dimensional modeling, and propose a video shooting plan that avoids such a subject. Furthermore, the system to which the technology according to the present disclosure is applied can detect, when a subject that may degrade the performance of the three-dimensional modeling has been shot, that subject, and further propose a video shooting plan for re-shooting.

### 2. Video Shooting Planning System According to Present disclosure and its Operation

### 2-1. Configuration Example of Video Shooting Planning System

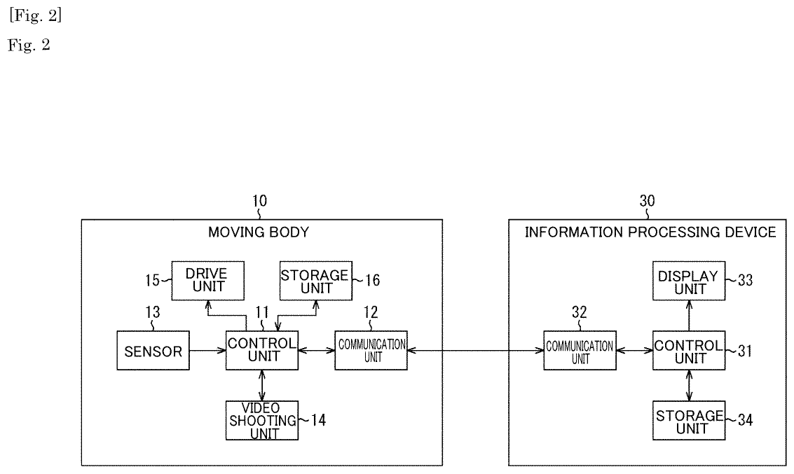

FIG. 2 is a diagram illustrating a configuration example of a video shooting planning system to which the technology according to the present disclosure can be applied.

The video shooting planning system illustrated in FIG. 2 includes a moving body 10 and an information processing device 30.

The moving body 10 may include a drone, an autonomous vehicle, an autonomous ship, an autonomous mobile robot such as an autonomous mobile vacuum cleaner, and the like. The moving body 10 will be described below as being configured of a drone. The moving body 10 includes a control unit 11, a a storage unit 16.

The control unit 11 includes a central processing unit (CPU), a memory, and the like, and controls the communication unit 12, the video shooting unit 14, the drive unit 15, and the storage unit 16 by executing a predetermined program.

The communication unit 12 includes a network interface and the like, and performs wireless or wired communication with the information processing device 30.

The sensor 13 includes various types of sensors, and senses the environment around the moving body 10 including the traveling direction of the moving body 10. By sensing the environment around the moving body 10, the moving body 10 is able to move autonomously.

The video shooting unit 14 includes a gimbal camera and the like, and executes video shooting under the control of the control unit 11 to acquire a shot image.

The drive unit 15 is a mechanism for moving the moving body 10, and includes a flying mechanism, a running mechanism, a propulsion mechanism, and the like. In this example, the moving body 10 is configured as a drone, and the drive unit 15 includes motors, propellers, and the like to implement a flying mechanism.

In a case where the moving body 10 is configured as an autonomous vehicle, the drive unit 15 includes wheels and the like to implement a driving mechanism, and in a case where the moving body 10 is configured as an autonomous ship, the drive unit 15 includes a screw propeller and the like to implement a propulsion mechanism. The drive unit 15 operates under the control of the control unit 11 to move the moving body 10.

The storage unit 16 includes an internal storage, a removable storage medium, and the like, and stores various types of information and images acquired by the video shooting unit 14 under the control of the control unit 11.

In the moving body 10 thus configured, the movement of the moving body 10 and the video shooting of the video shooting unit 14 are controlled based on video shooting plan information that indicates a video shooting plan for acquiring images from a plurality of viewpoints that has been prepared in advance.

The information processing device 30 includes a cloud server deployed on a cloud, a general-purpose computer such as a PC, and the like. The information processing device 30 may include a laptop PC, a tablet terminal, a transmitter (controller), and a smartphone, which are operated by a user who maneuvers and controls the moving body 10. The information processing device 30 includes a control unit 31, a communication unit 32, a display unit 33, and a storage unit 34.

The control unit 31 includes a processor such as a CPU, and controls each unit of the information processing device 30 by executing a predetermined program.

The communication unit 32 includes a network interface and the like, and performs wireless or wired communication with the moving body 10.

The display unit 33 includes a liquid crystal display, an organic EL display, or the like, and displays various types of information under the control of the control unit 31.

The storage unit 34 includes a non-volatile memory such as a flash memory and stores various types of information under the control of the control unit 31.

The information processing device 30 thus configured performs three-dimensional modeling using images shot from a plurality of viewpoints by the moving body 10.

### 2-2. Configuration with Which Three-Dimensional Modeling is Performed After Completion of Video Shooting

First, a configuration will be described with which three-dimensional modeling is performed after completion of video shooting based on video shooting plan information.

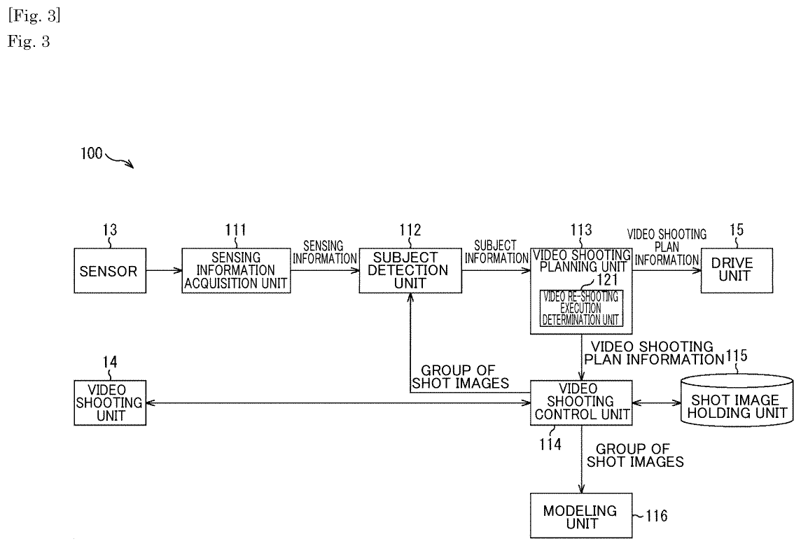

FIG. 3 is a block diagram illustrating a functional configuration example of the video shooting planning system described with reference to FIG. 2.

The video shooting planning system 100 illustrated in FIG. 3 includes a sensing information acquisition unit 111, a subject detection unit 112, a video shooting planning unit 113, a video shooting control unit 114, a shot image holding unit 115, and a modeling unit 116, in addition to the sensor 13, the video shooting unit 14, and the drive unit 15, which are included in the moving body 10 illustrated in FIG. 2.

For example, the sensing information acquisition unit 111, the subject detection unit 112, the video shooting planning unit 113, the video shooting control unit 114, and the shot image holding unit 115 are realized by the control unit 11 of the moving body 10, and the modeling unit 116 is realized by the control unit 31 of the information processing device 30. However, without being limited to this example, each functional block included in the video shooting planning system 100 can be realized by any of the control unit 11 of the moving body 10 and the control unit 31 of the information processing device 30.

The sensing information acquisition unit 111 acquires sensing information from the sensor 13 configured to include, for example, an RGB camera and a polarization camera, and supplies the information to the subject detection unit 112. The sensing information includes at least one of an RGB image, a polarized image, and an estimated self-position of the moving body 10.

The subject detection unit 112 performs detection processing to detect a subject around the moving body 10 based on the sensing information from the sensing information acquisition unit 111 each time a shot image is shot from each of the plurality of viewpoints, that is, at each of the shooting points corresponding to the plurality of viewpoints.

Specifically, the subject detection unit 112 performs, based on the sensing information, detection processing to detect a main subject that is to be subjected to the three-dimensional modeling using images shot from the plurality of viewpoints (hereinafter referred to as a subject of interest). The subject detection unit 112 also performs, based on the sensing information, detection processing to detect a subject that may degrade the performance of the three-dimensional modeling (hereinafter referred to as a defective subject). Subject information that indicates the subjects detected by these types of detection processing is supplied to the video shooting planning unit 113.

The video shooting planning unit 113 outputs, based on the subject information from the subject detection unit 112, video shooting plan information that indicates a video shooting plan for acquiring images shot from the plurality of viewpoints.

For example, when only the subject of interest is detected, that is, when only the subject information (subject-of-interest information) that indicates the subject of interest is supplied from the subject detection unit 112, the video shooting planning unit 113 outputs video shooting plan information prepared in advance as is.

On the other hand, when a defective subject is detected, that is, when the subject detection unit 112 supplies subject information (defective subject information) that indicates the defective subject in addition to the subject-of-interest information, the video shooting planning unit 113 outputs video shooting plan information for video shooting to reduce the region of the defective subject included in the shot image(s). Specifically, the video shooting planning unit 113 outputs video shooting plan information for video shooting in such a way that the region occupied by the defective subject in the shot image(s) is as small as possible without impeding the video shooting of the subject of interest that is to be subjected to the three-dimensional modeling.

The video shooting plan information may include, in addition to the predetermined pathway (flight path) of the moving body 10, the position and orientation of the moving body 10 at each of the shooting points corresponding to the plurality of viewpoints, and the orientation of the video shooting unit 14 (gimbal camera) included in the moving body 10.

Accordingly, when a defective subject is detected, the video shooting planning unit 113 outputs video shooting plan information in which at least one of the position and orientation of the moving body 10 and the orientation of the video shooting unit 14 at the corresponding shooting point has been corrected.

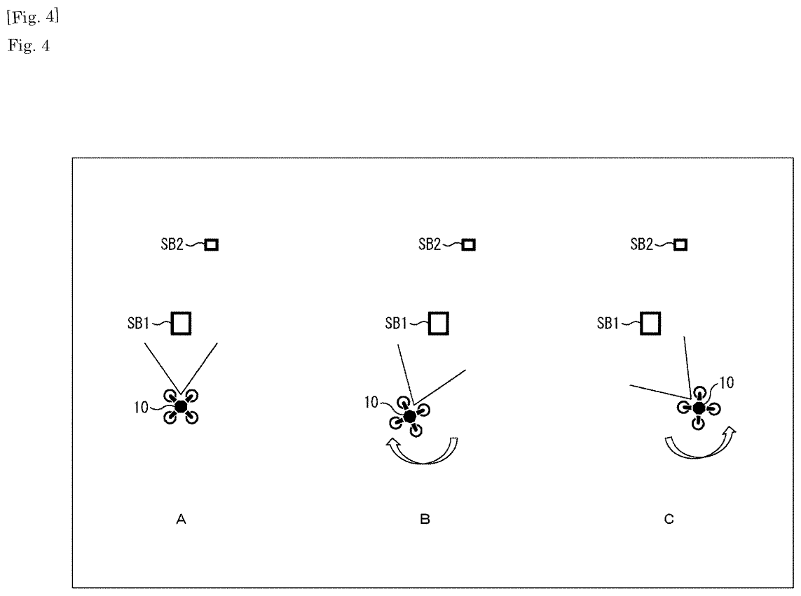

FIG. 4 is now referred to that is a diagram illustrating correction of the video shooting plan information.

In FIG. 4, diagram A illustrates a state (top view) in which the moving body 10 shoots an image of a subject of interest SB1. In diagram A, the moving body 10 and the video shooting unit 14 are in a position and orientation such that not only the subject of interest SB1 but also a defective subject SB2 present behind the subject of interest SB1 is included within the angle of view of a shot image.

In such a case, as illustrated in diagram B of FIG. 4, the position and orientation of the moving body 10 and the orientation of the video shooting unit 14 are corrected so that the subject of interest SB1 is included within the angle of view of a shot image and the defective subject SB2 is hidden by the subject of interest SB1 in the shot image.

As illustrated in diagram C of FIG. 4, the position and orientation of the moving body 10 and the orientation of the video shooting unit 14 are corrected so that the subject of interest SB1 is included within the angle of view of a shot image and the defective subject SB2 is excluded from the angle of view of the shot image.

In this manner, each time a defective subject is detected at each of the shooting points corresponding to the plurality of viewpoints, corrected video shooting plan information is output.

Based on the video shooting plan information output from the video shooting planning unit 113, the drive unit 15 moves the moving body 10 along a pathway included in the video shooting plan information, and adjusts the position and orientation of the moving body 10 at the corresponding shooting point.

The video shooting control unit 114 controls, based on the video shooting plan information output from the video shooting planning unit 113, the orientation of the video shooting unit 14 at the corresponding shooting point, and also controls the video shooting of the video shooting unit 14. The shot image(s) obtained by the video shooting of the video shooting unit 14 are stored in the shot image holding unit 115.

The shot image holding unit 115 stores the shot images shot by the video shooting unit 14 under the control of the video shooting control unit 114. The shot images (group of shot images) shot from the plurality of viewpoints stored in the shot image holding unit 115 are supplied to the modeling unit 116 via the video shooting control unit 114.

The modeling unit 116 performs the three-dimensional modeling of the subject of interest using the group of shot images from the video shooting control unit 114.

The group of shot images from the video shooting control unit 114 may also be supplied to the subject detection unit 112. In this case, the subject detection unit 112 performs detection processing to detect a defective subject based on the group of shot images (images shot from the plurality of viewpoints) from the video shooting control unit 114. When a defective subject is detected from any of the images shot from the plurality of viewpoints, subject information that indicates the defective subject is supplied to the video shooting planning unit 113.

The video shooting planning unit 113 includes a video re-shooting execution determination unit 121. The video re-shooting execution determination unit 121 determines, based on the subject information that indicates the defective subject detected from any of the images shot from the plurality of viewpoints, whether or not to re-shoot the shot image in which the defective subject has been detected. Specifically, the video re-shooting execution determination unit 121 determines whether or not to execute re-shooting depending on whether or not the defective subject can be excluded from the shot image(s) by executing video re-shooting.

When video re-shooting is determined to be executed for the shot image in which the defective subject has been detected, the video shooting planning unit 113 generates video shooting plan information for the video re-shooting.

### Operation of Video Shooting Planning System

Next, an operation of the video shooting planning system 100 illustrated in FIG. 3 will be described.

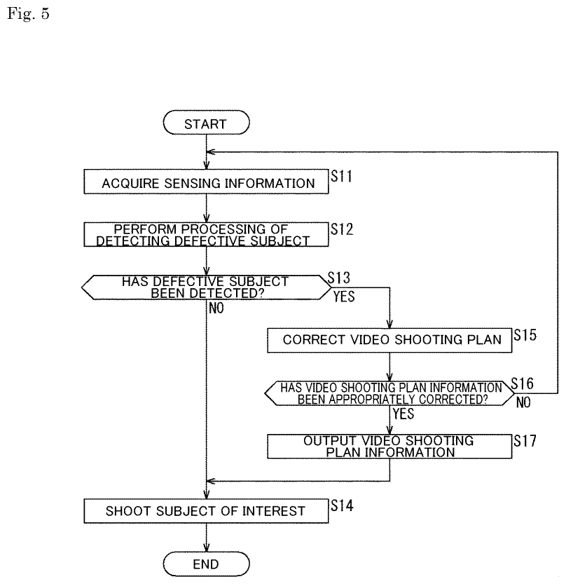

FIG. 5 is a flowchart illustrating moving body video shooting processing of the moving body 10.

The processing of FIG. 5 is performed at each of the shooting points corresponding to the plurality of viewpoints in the video shooting plan.

In step S11, the sensing information acquisition unit 111 acquires sensing information from the sensor 13.

In step S12, the subject detection unit 112 performs processing of detecting a subject of interest and processing of detecting a defective subject.

In step S13, the video shooting planning unit 113 determines whether or not a defective subject has been detected, that is, whether or not defective subject information has been supplied from the subject detection unit 112 together with subject-of-interest information.

If it is determined in step S13 that a defective subject has not been detected, the video shooting planning unit 113 outputs video shooting plan information prepared in advance to the video shooting control unit 114 as is, and then the processing proceeds to step S14.

In step S14, the video shooting control unit 114 shoots the subject of interest by controlling the video shooting of the video shooting unit 14 based on the video shooting plan information output from the video shooting planning unit 113.

The shot image shot by the video shooting unit 14 is stored in the shot image holding unit 115.

On the other hand, if it is determined in step S13 that a defective subject has been detected, the processing proceeds to step S15, where the video shooting planning unit 113 corrects the video shooting plan (video shooting plan information) prepared in advance. Specifically, the video shooting planning unit 113 corrects the position and orientation of the moving body 10 and the orientation of the video shooting unit 14 at the corresponding shooting point.

In step S16, the video shooting planning unit 113 determines whether or not the video shooting plan information has been appropriately corrected.

If it is determined in step S16 that the video shooting plan information could not be appropriately corrected, for example, when the video shooting plan information has not been corrected so that the defective subject is excluded from the angle of view of the shot image, the processing returns to step S11 to repeat the subsequent steps of processing.

On the other hand, if it is determined in step S16 that the video shooting plan information has been appropriately corrected, the processing proceeds to step S17, where the video shooting planning unit 113 outputs the video shooting plan information in which the position and orientation of the moving body 10 and the orientation of the video shooting unit 14 at the corresponding shooting point have been corrected.

In step S14 after step S17, the video shooting of the video shooting unit 14 is controlled based on the corrected video shooting plan information, thereby shooting the subject of interest.

According to the processing described above, the processing of detecting a defective subject is performed each time a shot image is shot from each of the plurality of viewpoints, and corrected video shooting plan information is output each time a defective subject is detected. This makes it possible to prevent a subject that may degrade the performance of the three-dimensional modeling from appearing in the shot image(s), and as a result, makes it possible to generate a more accurate three-dimensional model.

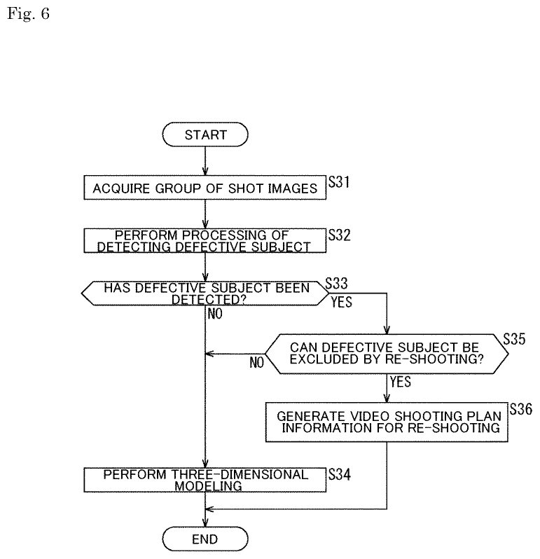

Next, an operation of the video shooting planning system 100 after the video shooting of the subject of interest at each of the shooting points corresponding to the plurality of viewpoints has been performed (after the completion of the video shooting) will be described with reference to a flowchart of FIG. 6.

The processing of FIG. 6 is started, for example, after the moving body 10 has landed after completing a flight based on the video shooting plan, while being communicatively connected to the information processing device 30.

In step S31, the video shooting control unit 114 acquires a group of shot images stored in the shot image holding unit 115.

In step S32, the subject detection unit 112 performs the processing of detecting a defective subject based on the group of shot images acquired by the video shooting control unit 114.

In step S33, the video shooting planning unit 113 determines whether or not a defective subject has been detected, that is, whether or not defective subject information has been supplied from the subject detection unit 112.

If it is determined in step S33 that a defective subject has not been detected, the video shooting control unit 114 supplies the group of shot images acquired from the shot image holding unit 115 to the modeling unit 116, and then the processing proceeds to step S34.

In step S34, the three-dimensional modeling of the subject of interest is performed using the group of shot images from the video shooting control unit 114.

In this manner, after the video shooting has been performed a plurality of times based on the video shooting plan information, the three-dimensional modeling of the subject of interest is performed using images (group of shot images) shot from the plurality of viewpoints.

On the other hand, if it is determined in step S33 that a defective subject has been detected, the processing proceeds to step S35, where the video re-shooting execution determination unit 121 of the video shooting planning unit 113 determines whether or not the defective subject can be excluded by re-shooting the shot image in which the defective subject has been detected.

If it is determined in step S35 that the defective subject can be excluded by re-shooting, the processing proceeds to step S36, where the video shooting planning unit 113 generates video shooting plan information for re-shooting the shot image in which the defective subject has been detected.

Based on the video shooting plan information thus generated, video re-shooting is performed at the corresponding shooting point where the defective subject has been detected.

If it is determined in step S35 that the defective subject cannot be excluded by video re-shooting, the processing proceeds to step S34, where the three-dimensional modeling of the subject of interest is performed using the group of shot images excluding the shot image in which the defective subject has been detected.

According to the processing described above, the processing of detecting a defective subject is performed based on shot images shot from the plurality of viewpoints obtained by executing video shooting a plurality of times, and when a defective subject is detected from any of the images shot from the plurality of viewpoints, video shooting plan information is generated for re-shooting the corresponding shot image. This makes it possible to propose a video shooting plan such that, even when a subject that may degrade the performance of the three-dimensional modeling appears in the shot image(s), that subject does not appear, and as a result, makes it possible to generate a more accurate three-dimensional model.

An example of the video shooting planning system that executes video shooting based on a short-term video shooting plan has been described above.

A typical pathway for video shooting for three-dimensional modeling is determined by estimating the shape of the subject of interest and following a trajectory around the subject of interest. At this time, the orientation of the body of the moving body and the gimbal camera is set perpendicular to the subject of interest.

In the video shooting planning system 100 of FIG. 3, while following the basic pathway as described above as an initial trajectory, the processing of detecting a defective subject is continuously performed, and the position and orientation of the camera are corrected so that the subject of interest is included within the angle of view and the defective subject is excluded from the angle of view.

Without being limited to this, in a system to which the technology according to the present disclosure is applied, video shooting can also be executed based on a long-term video shooting plan.

Specifically, when a moving body continues to move for a while, a map can be created based on its own position, orientation, and depth information during that time. In a typical path planning method, a cost map (hereinafter, simply called a map) is created based on the distance to an obstacle, and a path is determined so as to pass through regions with lower costs. In a system to which the technology according to the present disclosure is applied, a map is created with the presence of a defective subject that would degrade the performance of the three-dimensional modeling as a cost.

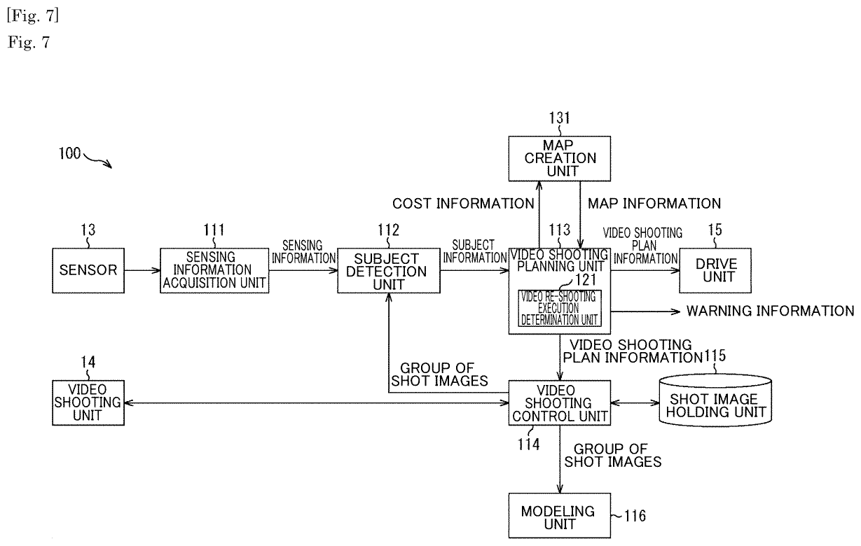

FIG. 7 is a block diagram illustrating a configuration example of a video shooting planning system for video shooting based on a long-term video shooting plan.

The video shooting planning system 100 of FIG. 7 differs from the video shooting planning system 100 of FIG. 3 in that a map creation unit 131 is newly provided. In the video shooting planning system 100 in FIG. 7, the video shooting planning unit 113 generates cost information based on the subject information from the subject detection unit 112, and supplies the cost information to the map creation unit 131. The cost information is generated based on the distances to obstacles present around the moving body 10.

When a defective subject is detected by the subject detection unit 112, the video shooting planning unit 113 generates, based on the subject information from the subject detection unit 112, evaluation information regarding a possibility that the detected defective subject will degrade the performance of the three-dimensional modeling as cost information. The cost information may include information indicating the position and orientation of the moving body 10 at the time when the shot image in which the defective subject is detected was shot.

The map creation unit 131 creates a map for setting a pathway of the moving body 10, based on the cost information from the video shooting planning unit 113. Map information that indicates the created map is supplied to the video shooting planning unit 113. The video shooting planning unit 113 generates video shooting plan information that indicates a video shooting plan (path plan), based on the map information (map) from the map creation unit 131.

When a defective subject is detected, the map creation unit 131 reflects, in the map, the evaluation information of the moving body 10 at the time when the shot image in which the defective subject is detected was shot.

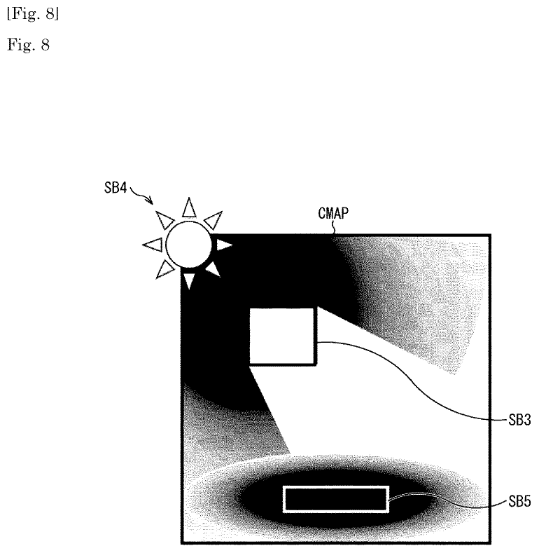

FIG. 8 illustrates an example of the map.

The map CMAP illustrated in FIG. 8 is a two-dimensional planar representation of the surroundings of the moving body 10 as seen from above, but a map that is actually created will be a three-dimensional representation. The map CMAP includes a subject of interest SB3, a sun SB4, and a moving object SB5. The sun SB4 and the moving object SB5 can be defective subjects.

In the map CMAP, the higher the density of black (closer to black), the higher the cost of the region, and the lower the density of black (closer to white), the lower the cost of the region.

Specifically, the map CMAP reflects a higher cost radially from the sun SB4, which is a defective subject, the closer to the sun SB4. The map CMAP also reflects a higher cost, the closer to the moving object SB5, which is a defective subject, within the range in which the moving object SB5 can move. However, in the map CMAP, when the subject of interest SB3 is viewed, the region where the sun SB4 is hidden by the subject of interest SB3 is unlikely to degrade the performance of the three-dimensional modeling and also has a low cost.

In addition, for a defective subject such as the sun SB4, whose behavior can be predicted without constant observation, the map can be updated appropriately according to the elapsed time since the map was created.

In this manner, a map is created that reflects the position of the defective subject present around the subject of interest and the cost based on the positional relationship of the defective subject with respect to the subject of interest.

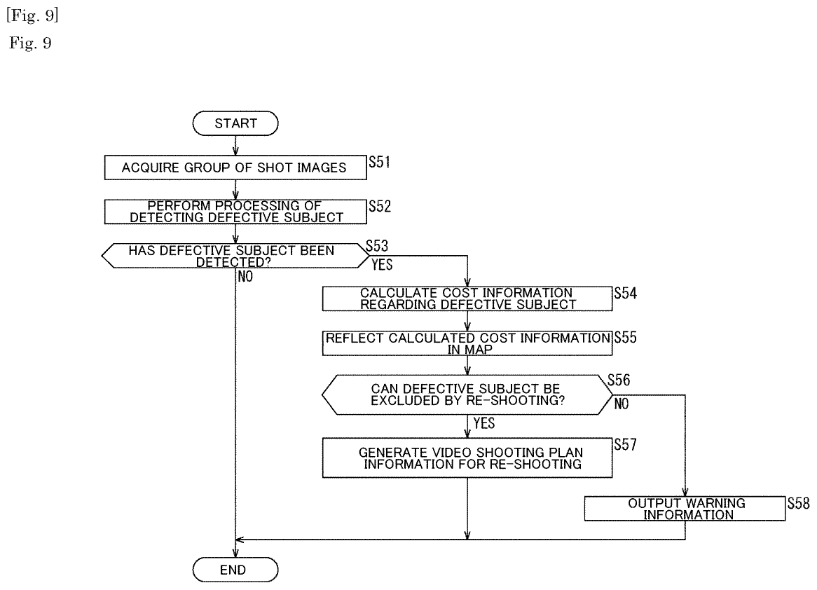

An operation of the video shooting planning system 100 of FIG. 7 will now be described with reference to a flowchart of FIG. 9.

The processing of FIG. 9 is performed after the video shooting of the subject of interest at each of the shooting points corresponding to the plurality of viewpoints (after the completion of the video shooting).

The processing of steps S51 to S53 in the flowchart of FIG. 9 is the same as the processing of steps S31 to S33 in the flowchart of FIG. 6, and accordingly, the description thereof will be omitted.

Specifically, if it is determined in step S53 that a defective subject has been detected, the processing proceeds to step S54, where the video shooting planning unit 113 calculates (generates) cost information regarding the defective subject based on the position and orientation of the moving body 10 and the position of the defective subject at the time when the shot image in which the defective subject is detected was shot.

In step S55, the map creation unit 131 reflects the cost information calculated by the video shooting planning unit 113 in the map created based on the distance(s) to the obstacle(s).

In step S56, the video re-shooting execution determination unit 121 of the video shooting planning unit 113 determines whether or not the defective subject can be excluded by re-shooting the shot image in which the defective subject has been detected, along a pathway based on the map. The pathway based on the map is determined to be a path that allows the moving body 10 to travel optimally, such as a path that prioritizes passing through regions with lower costs, or a path for traveling in a direction that is as low cost as possible when it is unavoidable to pass through a region with a certain degree of cost.

If it is determined in step S56 that the defective subject can be excluded by re-shooting, the processing proceeds to step S57, where the video shooting planning unit 113 generates video shooting plan information for re-shooting the shot image in which the defective subject has been detected.

On the other hand, if it is determined in step S56 that the defective subject cannot be excluded by re-shooting, the processing proceeds to step S58, where the video shooting planning unit 113 outputs warning information (FIG. 8) regarding the detected defective subject. For example, information informing the user of the position of the detected defective subject or the position of the moving body 10 at the time when the shot image in which the defective subject is detected was shot is output as warning information.

As a result, for a shot image in which a defective subject that cannot be excluded even after re-shooting has been detected, the shot image can be removed and input to the three-dimensional modeling algorithm.

According to the processing described above, when a defective subject is detected from among images shot from a plurality of viewpoints obtained by executing shooting a plurality of times, video shooting plan information for re-shooting the corresponding shot image is generated based on a map that reflects cost information regarding the defective subject. This makes it possible to more reliably propose a video shooting plan such that a subject that may degrade the performance of the three-dimensional modeling does not appear, and as a result, makes it possible to generate a more accurate three-dimensional model.

### 2-3. Configuration with Which Three-Dimensional Modeling is Performed in Parallel with Video Shooting

A configuration in which three-dimensional modeling is performed after completion of video shooting based on video shooting plan information has been described above. However, the technology according to the present disclosure can also be applied to a configuration in which three-dimensional modeling is performed in parallel with video shooting based on video shooting plan information.

In this example, the moving body 10 and the information processing device 30 are connected to each other online through wireless communication or the like.

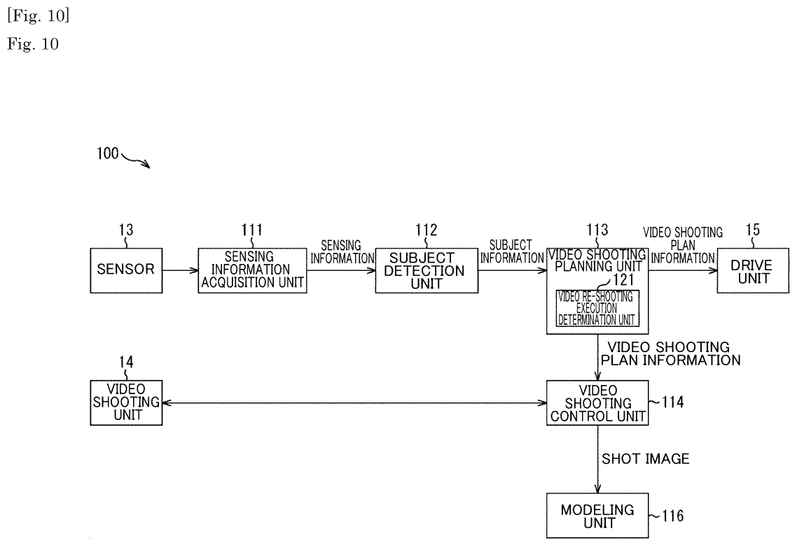

FIG. 10 is a diagram illustrating a first configuration example of a video shooting planning system 100 that performs three-dimensional modeling in parallel with video shooting.

The video shooting planning system 100 of FIG. 10 is basically configured in the same manner as the video shooting planning system 100 of FIG. 3, except that the shot image holding unit 115 is not provided.

However, the video shooting control unit 114 in the video shooting planning system 100 of FIG. 10 supplies the shot images shot by the video shooting unit 14 to the modeling unit 116 one by one, that is, for each shooting point.

This allows the video shooting planning system 100 of FIG. 10 to perform three-dimensional modeling in parallel with video shooting.

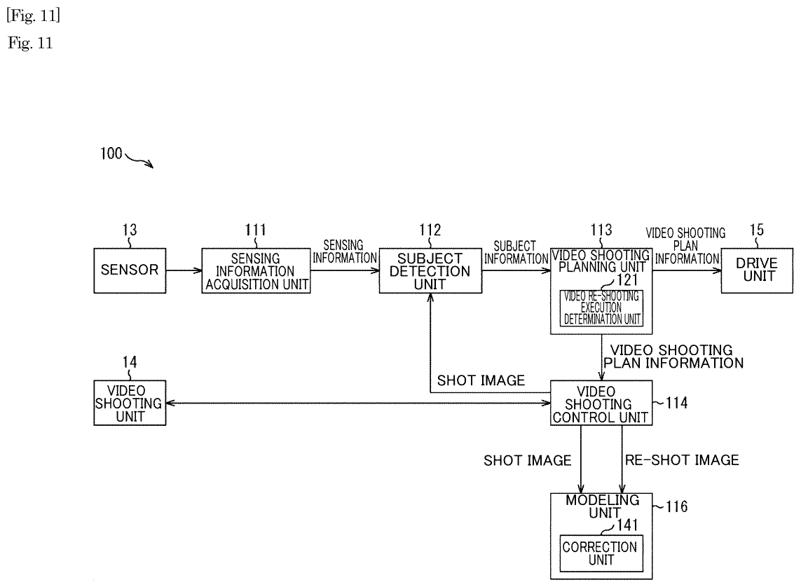

FIG. 11 is a diagram illustrating a second configuration example of a video shooting planning system 100 that performs three-dimensional modeling in parallel with video shooting.

The video shooting planning system 100 of FIG. 11 differs from the video shooting planning system 100 of FIG. 10 in that the modeling unit 116 includes a correction unit 141.

The video shooting control unit 114 in the video shooting planning system 100 of FIG. 11 supplies the shot images shot by the video shooting unit 14 to the modeling unit 116 and also to the subject detection unit 112 one by one, that is, for each shooting point.

The subject detection unit 112 performs the processing of detecting a defective subject based on the shot image from the video shooting control unit 114, and when a defective subject is detected, supplies subject information that indicates the defective subject to the video shooting planning unit 113.

The video re-shooting execution determination unit 121 of the video shooting planning unit 113 determines, based on the subject information from the subject detection unit 112, whether or not to re-shoot the shot image in which the defective subject has been detected, and if the shot image is determined to be re-shot, generates video shooting plan information for video re-shooting at the corresponding shooting point.

Then, the video shooting control unit 114 controls the video re-shooting of the video shooting unit 14 at the corresponding shooting point, and supplies the obtained re-shot image to the modeling unit 116.

When the re-shot image is supplied from the video shooting control unit 114, the correction unit 141 of the modeling unit 116 corrects, based on the re-shot image, the shot image in which a defective subject has been detected. For example, the correction unit 141 may replace the shot image in which a defective subject has been detected with the re-shot image as the image to be used for the three-dimensional modeling, or may correct information regarding the defective subject included in the shot image based on the re-shot image.

The modeling unit 116 performs the three-dimensional modeling of the subject of interest by using the shot image corrected by the correction unit 141.

This allows the video shooting planning system 100 of FIG. 11 to perform the three-dimensional modeling in parallel with the video re-shooting.

An embodiment of a system to which the technology according to the present disclosure is applied will be described below.

### 3. First Embodiment (Detection of Defective Subject by Semantics Estimation)

In the present embodiment, a defective subject is detected based on attribute information of an object obtained by semantics estimation of the object included within the angle of view of an image acquired as sensing information, and video shooting is executed in a position and orientation where the defective subject is hidden.

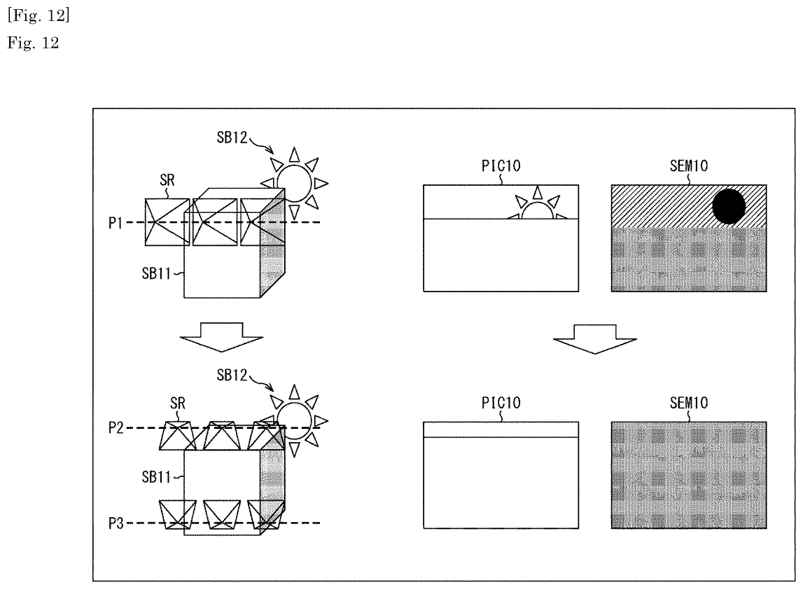

As illustrated on the upper left side in FIG. 12, it is assumed that a moving body shoots a subject of interest SB11 at shooting points on a path P1. In this case, an angle of view SR includes a sun SB12 as a defective subject located behind and above the subject of interest SB11, so that the sun SB12 appears in an image PIC10 illustrated on the upper right side in FIG. 12. To the right of the image PIC10, a semantics estimation result SEM10 for the objects included in the angle of view SR is illustrated, with a region corresponding to the sun SB12 indicated by a black circle.

In the present embodiment, as illustrated on the lower side in FIG. 12, the semantics estimation result SEM10 is made not to include the black circle, that is, the image PIC10 is made not to include the sun SB12. Specifically, the moving body shoots the subject of interest SB11 at shooting points that overlook the subject of interest SB11 on a path P2, so that the sun SB12 is not included in the angle of view SR. In addition, the moving body shoots the subject of interest SB11 at shooting points that look up at the subject of interest SB11 on a path P3, so that the sun SB12 is hidden by the subject of interest SB11.

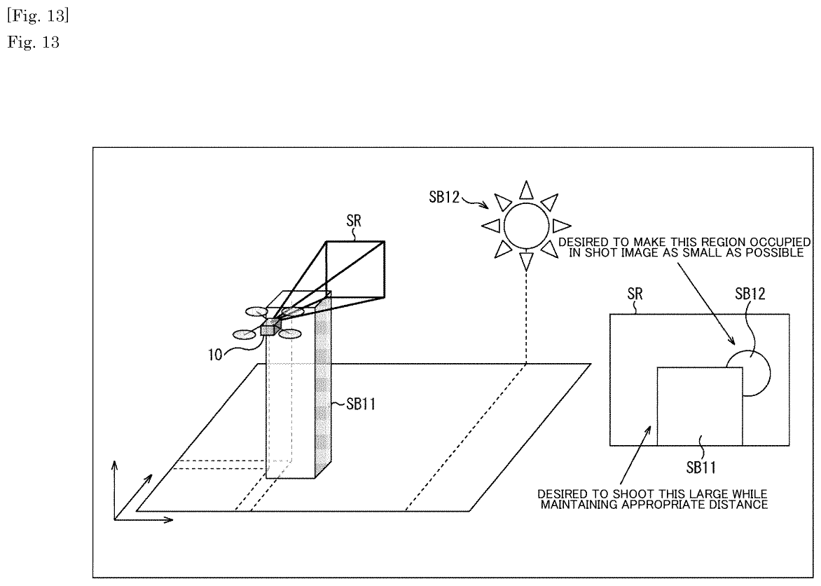

For example, as illustrated in FIG. 13, it is desirable to shoot the subject of interest SB11 large while maintaining an appropriate distance at the angle of view SR, and to make the region occupied by the sun SB12 as small as possible.

At this time, since the moving body 10 knows the camera parameters of the video shooting unit 14, it is possible for the moving body 10 to three-dimensionally grasp its own position and orientation, the position and depth of the subject of interest SB11, and the position of the sun SB12, which is a defective subject.

Therefore, the moving body 10 can estimate how the field of view (the range included in the angle of view SR) will change depending on how its own position and orientation changes, even without actually moving.

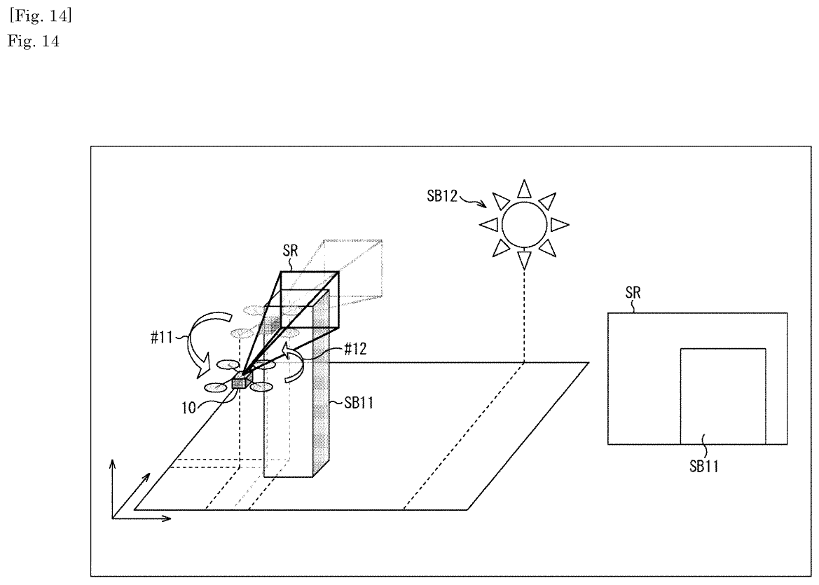

Therefore, as illustrated in FIG. 14, the moving body 10 changes its own position and orientation (arrow #11 in the figure) and changes the orientation of the video shooting unit 14 (gimbal camera) (arrow #12 in the figure). This makes it possible to make the sun SB12 hidden by the subject of interest SB11 at the angle of view SR.

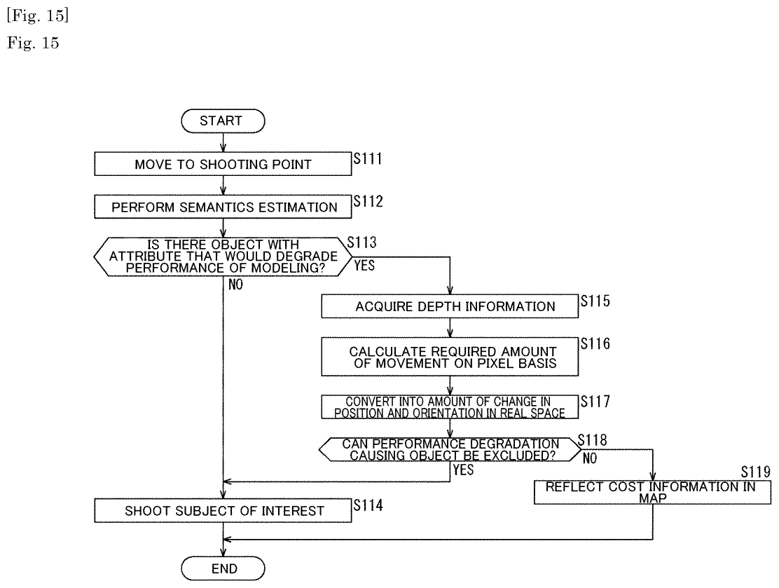

FIG. 15 is a flowchart illustrating video shooting processing of the moving body 10 according to the present embodiment. The moving body 10 according to the present embodiment can be realized by the video shooting planning system 100 illustrated in FIG. 7 that is capable of creating a map.

The processing of FIG. 15 is performed at each of the shooting points corresponding to the plurality of viewpoints in the video shooting plan.

In step S111, the drive unit 15 moves the moving body 10 to the shooting point.

In step S112, the subject detection unit 112 uses the sensing information acquired by the sensing information acquisition unit 111 to perform semantics estimation on the surrounding region including the subject of interest.

In step S113, the video shooting planning unit 113 determines, based on the semantics estimation result, whether or not there is an object with an attribute that would degrade the performance of the three-dimensional modeling.

If it is determined in step S113 that there is no object with an attribute that would degrade the performance of the three-dimensional modeling, the processing proceeds to step S114, where the video shooting control unit 114 shoots the subject of interest by controlling the video shooting unit 14.

On the other hand, if it is determined in step S113 that there is an object with an attribute that would degrade the performance of the three-dimensional modeling (a performance degradation causing object), the processing proceeds to step S115, where the video shooting planning unit 113 acquires depth information of the surrounding region including the subject of interest from the sensing information acquired by the sensing information acquisition unit 111.

In step S116, the video shooting planning unit 113 calculates, based on the acquired depth information, the required amount of movement of the moving body 10 on a pixel basis in the RGB image acquired as the sensing information.

Specifically, in order to maximize the semantic region of the subject of interest while minimizing the semantic region of the performance degradation causing object, it is calculated how far and in what direction each pixel in the RGB image is to be moved.

In step S117, the video shooting planning unit 113 converts the required amount of movement calculated on a pixel basis into an amount of change in position and orientation in real space. Here, by grasping the position and orientation of the moving body 10, the position of the subject of interest, the position of the performance degradation causing object, and the camera parameters of the video shooting unit 14, an amount of change in position and orientation in real space can be calculated corresponding to the required amount of movement of each pixel in the image.

In step S118, the video shooting planning unit 113 determines whether or not the performance degradation causing object can be excluded from the angle of view of the shot image based on the calculated change in the position and orientation of the moving body 10 in real space.

If it is determined in step S118 that the performance degradation causing object can be excluded from the angle of view of the shot image, the drive unit 15 changes the position and orientation of the moving body 10 by the calculated amount of change in the position and orientation in real space, and then in step S114, the subject of interest is shot. Here, the amount of change in the position and orientation may further include an amount of change in the orientation of the video shooting unit 14, and the orientation of the video shooting unit 14 may be changed to shoot the subject of interest.

On the other hand, if it is determined in step S118 that the performance degradation causing object cannot be excluded from the angle of view of the shot image, the subject detection unit 112 supplies cost information regarding the performance degradation causing object to the map creation unit 131, and then the processing proceeds to step S119.

In step S119, the map creation unit 131 reflects the cost information regarding the performance degradation causing object in the map. This makes it possible to propose a video shooting plan that avoids the performance degradation causing object when the moving body 10 executes video re-shooting.

According to the processing described above, each time a shot image is shot from each of the plurality of viewpoints, the processing of detecting a performance degradation causing object by semantics estimation is performed, and when a performance degradation causing object is detected, video shooting is executed in a position and orientation where the performance degradation causing object is hidden. This makes it possible to prevent a subject that may degrade the performance of the three-dimensional modeling from appearing in the shot image(s), and thus makes it possible to generate a more accurate three-dimensional model.

### 4. Second Embodiment (Detection of Defective Subject by Optical Flow Estimation)

In the present embodiment, a moving object that is a defective subject is detected based on object movement information obtained by optical flow estimation using images acquired as sensing information, and video shooting is executed in a position and orientation that allows the moving object to be quickly moved from the angle of view or minimizes the region where the moving object occupies in the image.

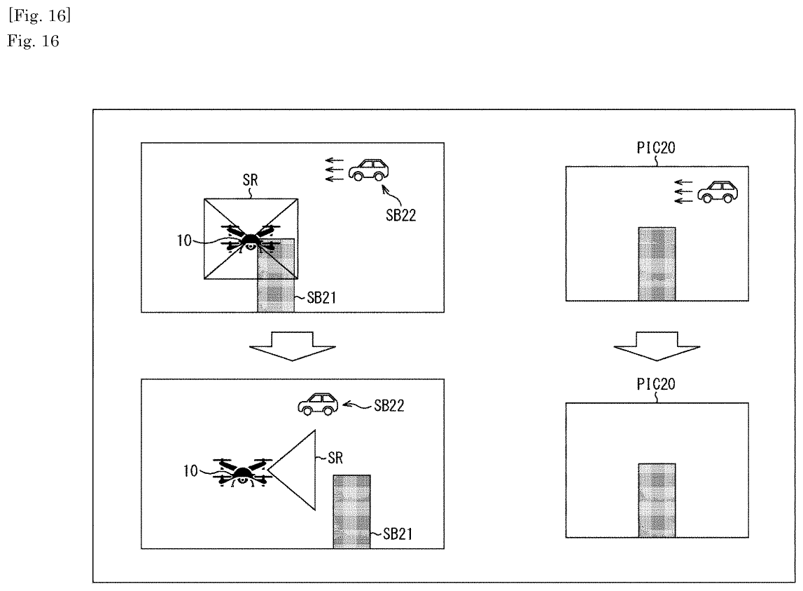

As illustrated on the upper left side in FIG. 16, it is assumed that a moving body 10 shoots a subject of interest SB21 at a certain shooting point. In this case, an angle of view SR includes a moving object SB22 as a defective subject moving from right to left behind the subject of interest SB21, so that the moving object SB22 appears in an image PIC20 illustrated on the upper right side in FIG. 16.

In the present embodiment, as illustrated on the lower side in FIG. 16, the moving object SB22 is prevented from entering the image PIC20. Specifically, the moving body 10 shoots the subject of interest SB21 from a shooting point that allows the moving object SB22 to be quickly moved from the angle of view SR, thereby preventing the moving object SB22 from entering the angle of view SR.

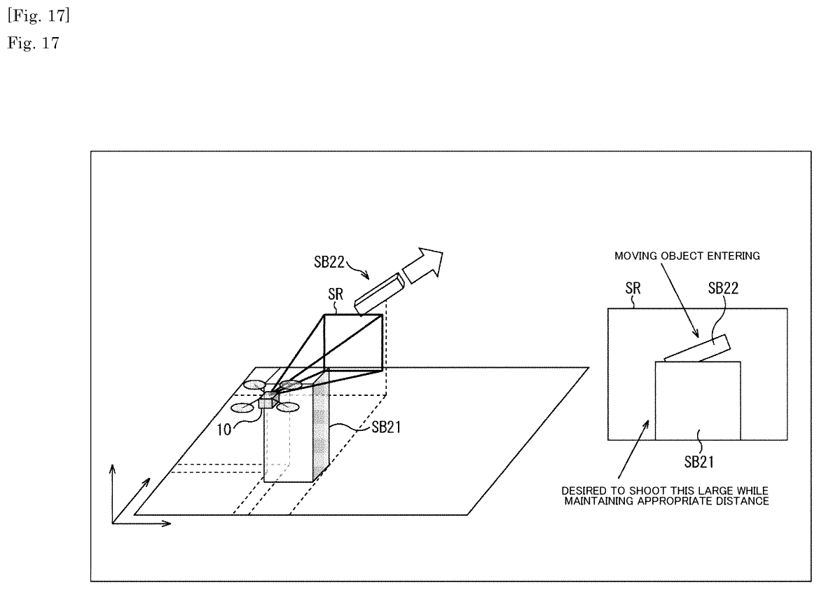

For example, as illustrated in FIG. 17, it is desirable to shoot the subject of interest SB21 large while maintaining an appropriate distance at the angle of view SR, while the moving object SB22 moving diagonally upward and to the right behind the subject of interest SB21 may enters there.

At this time, it is possible for the moving body 10 to three-dimensionally grasp its own position and orientation, the position and depth of the subject of interest SB21, and the position of the moving object SB22, which is a defective subject.

Therefore, the moving body 10 can estimate how the field of view (the range included in the angle of view SR) will change depending on how the position and orientation of the moving body itself changes.

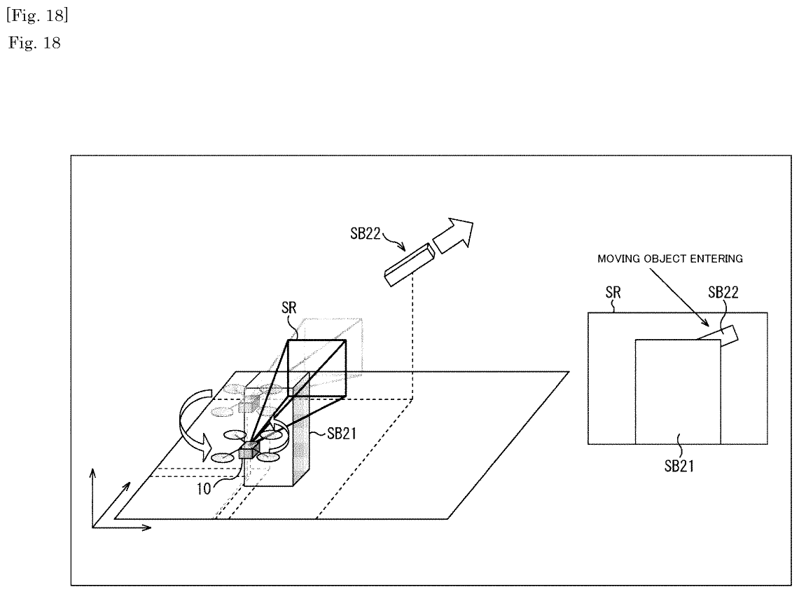

Therefore, as illustrated in FIG. 18, the moving body 10 changes its own position and orientation and changes the orientation of the video shooting unit 14 (gimbal camera), in the same manner as in the first embodiment. However, simply optimizing the position and orientation of the moving body based on the factors at that moment, as in the first embodiment, is not able to respond to the movement of the moving object SB22, and the moving object SB22 will enter the angle of view SR.

On the other hand, the moving body 10 is not only able to three-dimensionally grasp its own position and orientation, the position and depth of the subject of interest SB21, and the position of the moving object SB22, which is a defective subject, but is also able to grasp the speed and direction of movement of the moving object SB22. Therefore, the moving body 10 can estimate how the field of view will change depending on how and for how long the position and orientation of the moving body 10 changes.

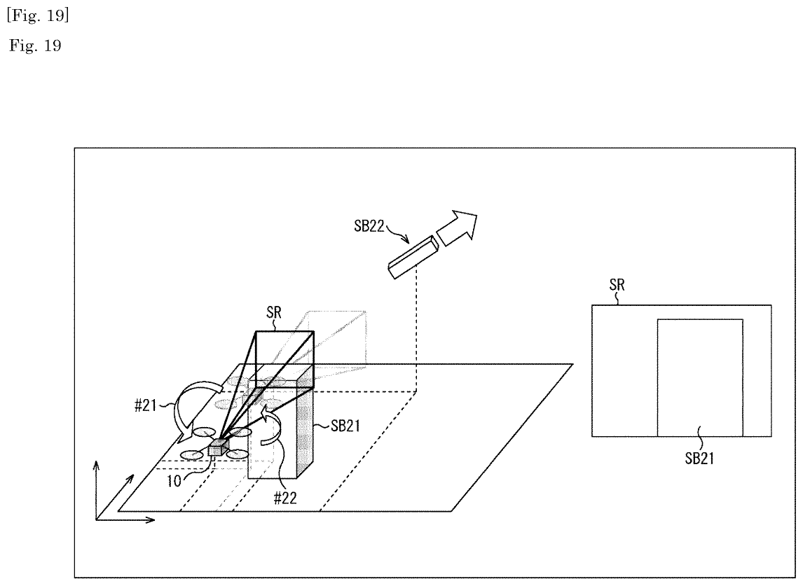

Therefore, in the present embodiment, as illustrated in FIG. 19, the moving body 10 changes its own position and orientation (arrow #21 in the figure) and changes the orientation of the video shooting unit 14 (gimbal camera) (arrow #22 in the figure) based on time-series factors such as how the environment changes from moment to moment. This makes it possible to prevent the moving object SB22 from entering the angle of view SR.

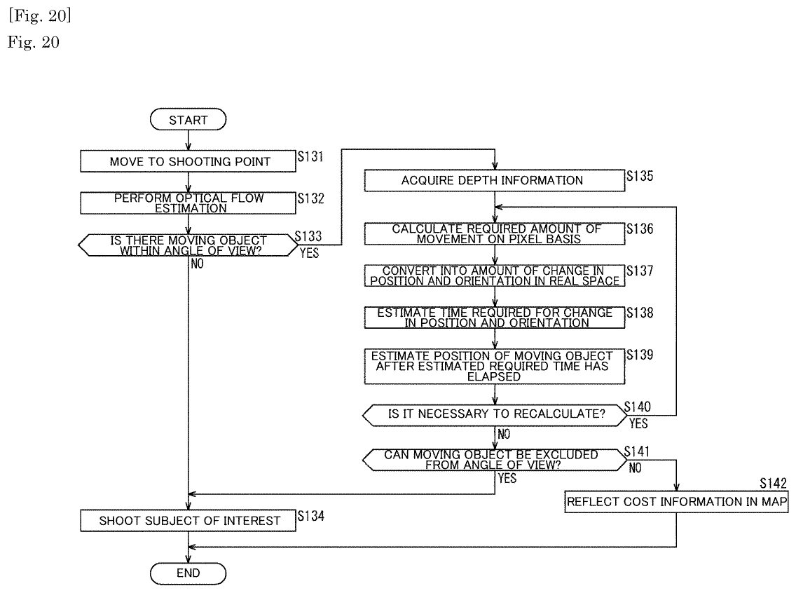

FIG. 20 is a flowchart illustrating video shooting processing of the moving body 10 according to the present embodiment. The moving body 10 according to the present embodiment can also be realized by the video shooting planning system 100 illustrated in FIG. 7 that is capable of creating a map.

The processing of FIG. 20 is performed at each of the shooting points corresponding to the plurality of viewpoints in the video shooting plan.

In step S132, the subject detection unit 112 uses the sensing information acquired by the sensing information acquisition unit 111 to perform optical flow estimation on the surrounding region including the subject of interest.

In step S133, the video shooting planning unit 113 determines, based on the object movement information obtained by the optical flow estimation, whether or not there is a moving object within the angle of view of the RGB image acquired as the sensing information.

If it is determined in step S133 that there is no moving object within the angle of view, the processing proceeds to step S134, where the video shooting control unit 114 shoots the subject of interest by controlling the video shooting unit 14.

On the other hand, if it is determined in step S133 that there is a moving object within the angle of view, the processing proceeds to step S135, where the video shooting planning unit 113 acquires depth information of the surrounding region including the subject of interest from the sensing information acquired by the sensing information acquisition unit 111.

In step S136, the video shooting planning unit 113 calculates the required amount of movement of the moving body 10 on a pixel basis in the RGB image acquired as the sensing information.

In step S137, the video shooting planning unit 113 converts the required amount of movement calculated on a pixel basis into an amount of change in position and orientation in real space.

In step S138, the video shooting planning unit 113 estimates the time required for a change in the position and orientation of the moving body 10 based on the motion characteristics of the moving body 10.

In step S139, the video shooting planning unit 113 estimates the position of the moving object after the time required for the estimated change in the position and orientation (estimated required time) has elapsed. The position of the moving object after the estimated required time has elapsed can be calculated based on, for example, optical flow.

In step S140, the video shooting planning unit 113 determines, based on information on how the environment will change, whether or not it is necessary to recalculate the amount of change in the position and orientation of the moving body 10 and the estimated required time.

If it is determined in step S140 that it is necessary to recalculate, the processing returns to step S136 to repeat the subsequent steps of processing. On the other hand, if it is determined in step S140 that it is not necessary to recalculate, the processing proceeds to step S141.

In step S141, the subject detection unit 112 determines whether or not the moving object can be excluded from the angle of view of the shot image based on the calculated amount of change in the position and orientation of the moving body 10 in real space.

If it is determined in step S141 that the moving object can be excluded from the angle of view of the shot image, the drive unit 15 changes the position and orientation of the moving body 10 by the calculated amount of change in the position and orientation in real space, and then in step S134, the subject of interest is shot. Here, the amount of change in the position and orientation may further include an amount of change in the orientation of the video shooting unit 14, and the orientation of the video shooting unit 14 may be changed to shoot the subject of interest.

On the other hand, if it is determined in step S141 that the moving object cannot be excluded from the angle of view of the shot image, the subject detection unit 112 supplies cost information regarding the moving object to the map creation unit 131, and then the processing proceeds to step S142.

In step S142, the map creation unit 131 reflects the cost information regarding the moving object in the map. This makes it possible to propose a video shooting plan that avoids the moving object when the moving body 10 executes video re-shooting.

According to the processing described above, each time a shot image is shot from the plurality of viewpoints, the processing of detecting a moving object is performed by optical flow estimation is performed, and when a moving object is detected, video shooting is executed in a position and orientation where the moving object does not appear. This makes it possible to prevent a subject that may degrade the performance of the three-dimensional modeling from appearing in the shot image(s), and thus makes it possible to generate a more accurate three-dimensional model.

### 5. Third Embodiment (Detection of Defective Subject in Dark Place)

When three-dimensional modeling of a subject of interest shot in a dark place is performed, the subject of interest may be illuminated with light from a light source (lighting device) mounted on a moving body, but the light reflected from the subject of interest can be a factor that degrades the performance of the three-dimensional modeling. In other words, the surface of the subject of interest that can reflect light from the light source onto the moving body becomes a defective subject.

Therefore, in the present embodiment, based on the surface shape of an object (subject of interest) obtained using sensing information, video shooting is executed in a position and orientation that avoids reflected light that degrades the performance of the three-dimensional modeling, or keeps the intensity of the reflected light constant.

### First Example

When the surface shape of the object (subject of interest) is simple, the surface shape of the object is recognized, and video shooting is executed in a position and orientation that always allows reflected light to be avoided.

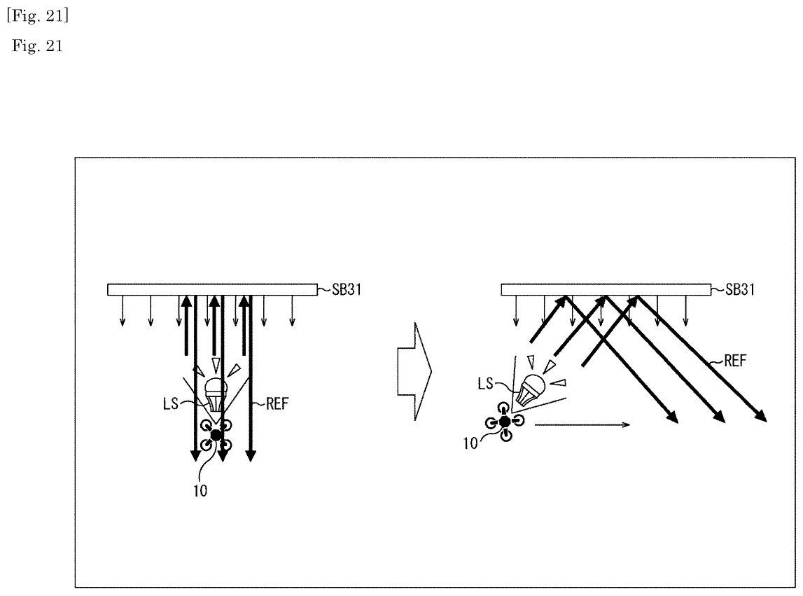

For example, as illustrated on the left side in FIG. 21, when a moving body 10 illuminates a subject of interest SB31 having a flat surface with light from a light source LS in a perpendicular direction, reflected light REF reflected from the surface of subject of interest SB31 will be received.

In a first example of the present embodiment, as illustrated on the right side in FIG. 21, the moving body 10 recognizes the surface shape of the subject of interest SB31, and shoots the subject of interest SB31 from a position where it does not receive the reflected light REF. The position where it does not receive the reflected light REF, for example, a position that always allows the subject of interest SB31 to be illuminated with light from the light source LS in a 45°direction, or a position that allows the surface of the recognized subject of interest SB31 to be illuminated with light from the light source LS in a specific direction.

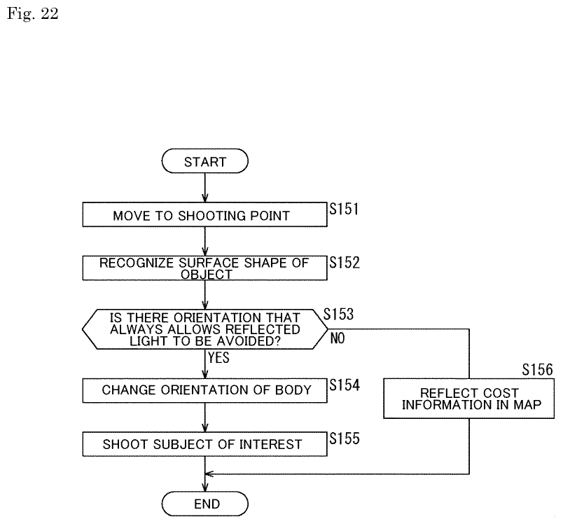

FIG. 22 is a flowchart illustrating video shooting processing of the moving body 10 according to the first example of the present embodiment. The moving body 10 according to the present embodiment can also be realized by the video shooting planning system 100 illustrated in FIG. 7 that is capable of creating a map.

The processing of FIG. 22 is performed at each of the shooting points corresponding to the plurality of viewpoints in the video shooting plan.

In step S151, the drive unit 15 moves the moving body 10 to the shooting point. In step S152, the subject detection unit 112 performs shape recognition using the sensing information acquired by the sensing information acquisition unit 111 to recognize the surface shape of an object (subject of interest), thereby performing processing of detecting the surface of the subject of interest that is a defective subject.

In step S153, the video shooting planning unit 113 determines, based on the detected surface of the subject of interest, whether or not there is an orientation that always allows reflected light from the surface of the subject of interest to be avoided.

If it is determined in step S153 that there is an orientation that always allows reflected light to be avoided, the video shooting planning unit 113 outputs video shooting plan information including the orientation of the moving body 10 that always allows reflected light to be avoided, and then the processing proceeds to step S154.

In step S154, the drive unit 15 changes the orientation of the body of the moving body 10 to an orientation that always allows reflected light to be avoided, based on the video shooting plan information output from the video shooting planning unit 113.

In step S155, the video shooting control unit 114 shoots the subject of interest by controlling the video shooting unit 14 based on the video shooting plan information output from the video shooting planning unit 113.

On the other hand, if it is determined in step S153 that there is no orientation that always allows reflected light to be avoided, the video shooting planning unit 113 supplies cost information regarding the surface of the subject of interest to the map creation unit 131, and then the processing proceeds to step S156.

In step S156, the map creation unit 131 reflects the cost information regarding the surface of the subject of interest in the map. This makes it possible to propose a video shooting plan that avoids video shooting of the subject of interest at the corresponding shooting position when the moving body 10 executes video re-shooting.

According to the processing described above, each time a shot image is shot from each of the plurality of viewpoints in a dark place, the processing of detecting the surface of the subject of interest is performed, and video shooting is executed in a position and orientation that allows reflected light from the surface of the detected subject of interest to be avoided. This makes it possible to prevent a subject that may degrade the performance of the three-dimensional modeling from appearing in the shot image(s), and thus makes it possible to generate a more accurate three-dimensional model.

### Second Example

When the surface shape of the object (subject of interest) is complex, video shooting is executed in a position and orientation that suppresses reflected light and keeps the intensity of the reflected light constant, based on normal information of the object surface.

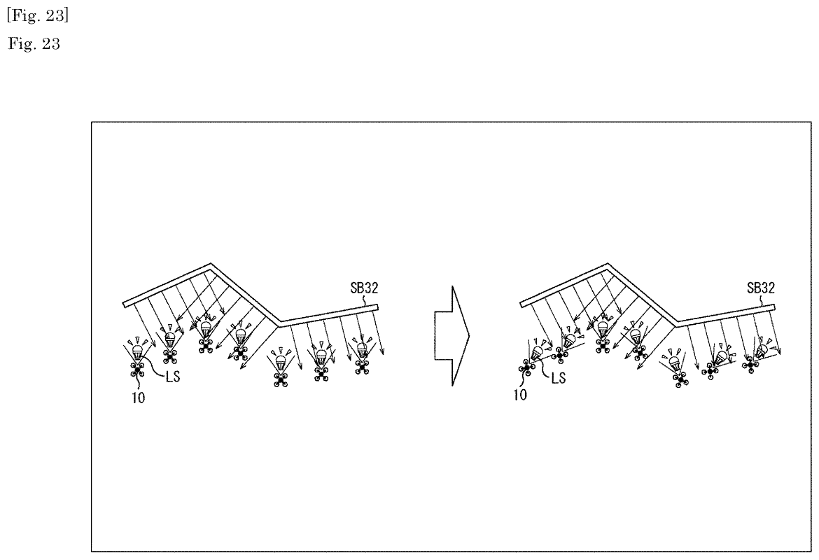

For example, as illustrated on the left side in FIG. 23, when a moving body 10 illuminates a subject of interest SB32 having a complex surface shape with light from a light source LS in the same direction, reflected light from the surface of the subject of interest SB32 will be received with different intensities depending on the shooting point.

In a second example of the present embodiment, as illustrated on the right side in FIG. 23, the moving body 10 executes, based on the normal information of the subject of interest SB32, video shooting in a position and orientation that suppresses reflected light and keeps the intensity of the reflected light constant.

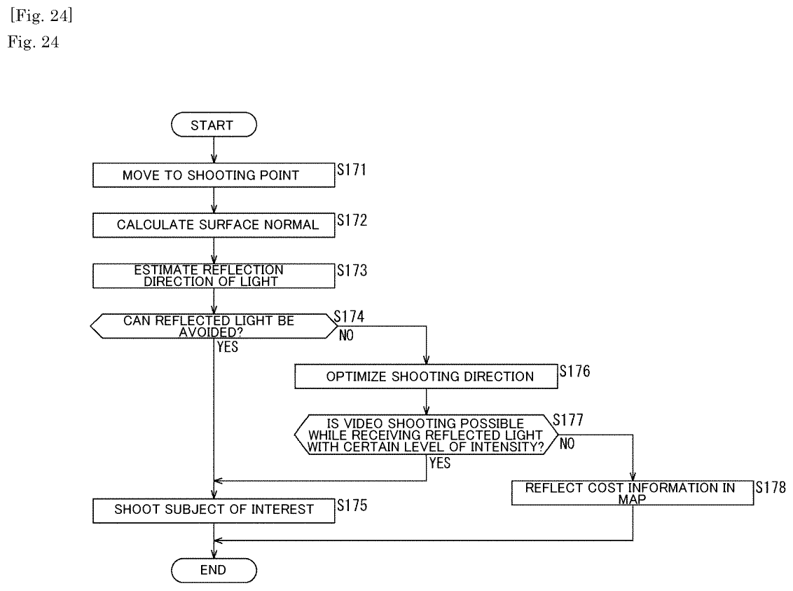

FIG. 24 is a flowchart illustrating video shooting processing of the moving body 10 according to the second example of the present embodiment. The moving body 10 according to the present embodiment can also be realized by the video shooting planning system 100 illustrated in FIG. 7 that is capable of creating a map.

The processing of FIG. 24 is performed at each of the shooting points corresponding to the plurality of viewpoints in the video shooting plan.

In step S171, the drive unit 15 moves the moving body 10 to the shooting point.

In step S172, the subject detection unit 112 uses the sensing information acquired by the sensing information acquisition unit 111 to calculate the surface normal of the surface of the object (subject of interest), thereby performing processing of detecting normal information of the surface of the subject of interest that is a defective subject.

In step S173, the video shooting planning unit 113 estimates the reflection direction of light from the light source based on the detected normal information of the surface of the subject of interest.

In step S174, the video shooting planning unit 113 determines, based on the estimated reflection direction of light, whether or not the moving body 10 can avoid the reflected light.

If it is determined in step S174 that the reflected light can be avoided, the processing proceeds to step S154, where the video shooting control unit 114 shoots the subject of interest by controlling the video shooting unit 14.

On the other hand, if it is determined in step S174 that the reflected light cannot be avoided, the processing proceeds to step S176, where the video shooting planning unit 113 optimizes the shooting direction. Here, for example, a shooting direction is calculated in which the intensity of reflected light from the subject of interest is a certain level.

In step S177, the video shooting planning unit 113 determines whether or not video shooting is possible while receiving reflected light with the certain level of intensity in the optimized shooting direction.

If it is determined in step S177 that video shooting is possible while receiving reflected light with the certain level of intensity, then in step S175, the subject of interest is shot in a state where it is receiving reflected light with the certain level of intensity.

On the other hand, if it is determined in step S177 that video shooting is not possible while receiving reflected light with the certain level of intensity, the video shooting planning unit 113 supplies cost information regarding the surface of the subject of interest to the map creation unit 131, and then the processing proceeds to step S178.

In step S178, the map creation unit 131 reflects the cost information regarding the surface of the subject of interest in the map. This makes it possible to propose a video shooting plan that avoids video shooting of the subject of interest at the corresponding shooting position when the moving body 10 executes video re-shooting.

According to the processing described above, each time a shot image is shot from each of the plurality of viewpoints in a dark place, the processing of detecting normal information of the surface of the subject of interest is performed, and when the reflected light cannot be avoided, video shooting is executed while receiving reflected light with the certain level of intensity. This makes it possible to suppress variations in brightness between shot images, and thus makes it possible to generate a more accurate three-dimensional model.

### 6. Modification Examples

Modification examples of the embodiments of the system to which the technology according to the present disclosure is applied will be described below.

### Modification Example 1

As the processing of detecting a defective subject, the subject detection unit 112 may detect a subject with a specific texture as a defective subject based on texture information obtained by pattern matching using the sensing information from the sensing information acquisition unit 111. In this case, the video shooting planning unit 113 outputs video shooting plan information that indicates a video shooting plan (pathway and position and orientation) such that the detected subject with the specific texture is avoided.

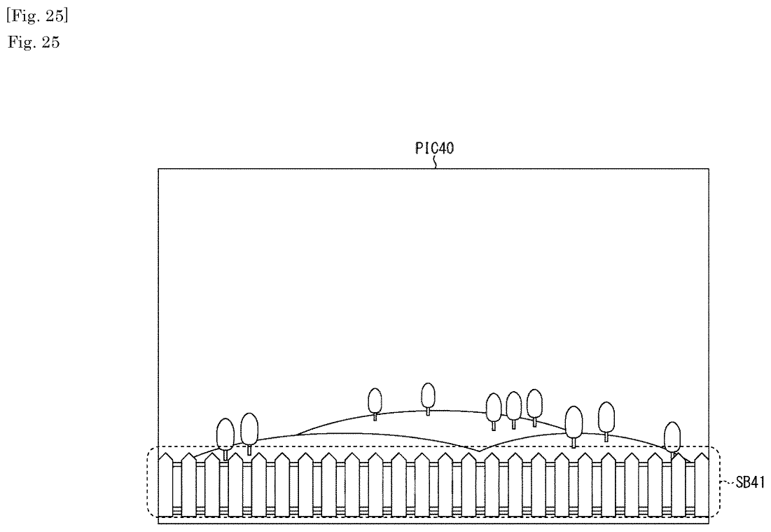

The specific texture referred to here is a texture with which it is difficult to associate feature points in three-dimensional modeling. For example, the subject detection unit 112 detects a repeating pattern such as a fence SB41 included in an image PIC40 illustrated in FIG. 25 as a defective subject. This makes it possible to prevent a subject that may degrade the performance of the three-dimensional modeling from appearing in the shot image(s).

### Modification Example 2

As the processing of detecting a defective subject, the subject detection unit 112 may detect at least one of a blown-out highlight and a crushed shadow included in the RGB image as the sensing information from the sensing information acquisition unit 111 as a defective subject. In this case, the video shooting planning unit 113 outputs video shooting plan information that indicates a video shooting plan (pathway and position and orientation) such that the detected blown out highlight and/or crushed shadow are excluded from the angle of view of the shot image.

### Modification Example 3

Subjects that continue to move periodically, such as tree branches and leaves, are also considered to be one of the subjects for which it is difficult to associate feature points in three-dimensional modeling. Therefore, when a subject that continues to move periodically is included as a subject of interest, video shooting may be executed over a short period of time so that only the images shot over the short period of time are input to the three-dimensional modeling algorithm. In this case, for example, the region of trees is estimated by semantics estimation, and video shooting plan information is output such that the moving speed of the moving body 10 is controlled so that the region is shot in a short period of time.

Not limited to the above-described embodiments and modification examples, the technology according to the present disclosure makes it possible to output shooting plan information for video shooting that sets any subject that may degrade the performance of the three-dimensional modeling as a defective subject and makes the defective subject smaller in the shot image.

### 7. Configuration Example of Computer

The above-described series of processing can also be performed by hardware or software. In a case where the series of processing is performed by software, a program that constitutes the software is installed on a computer. In this case, the computer includes, for example, a computer built into dedicated hardware and a general-purpose personal computer in which various programs are installed to enable the personal computer to implement various types of functions.

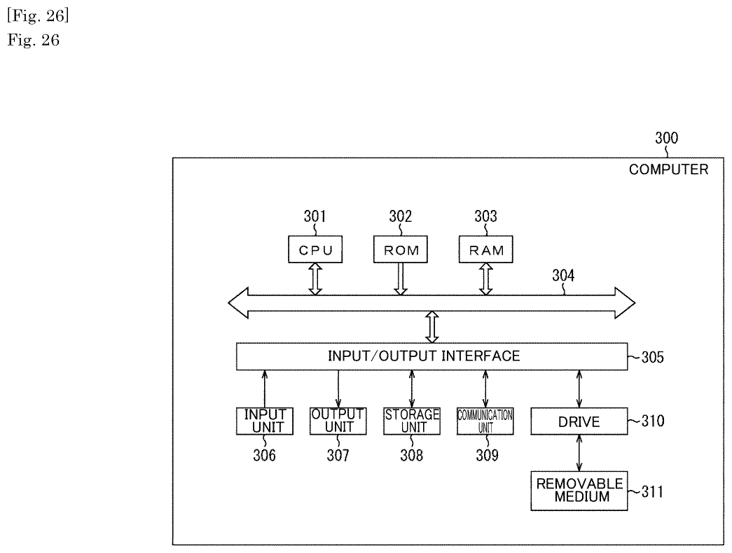

FIG. 26 is a block diagram illustrating a configuration example of computer hardware that executes the above-described series of processing using a program.

In the computer, a CPU 301, a read only memory (ROM) 302, and a random access memory (RAM) 303 are connected to one another via a bus 304.

An input/output interface 305 is further connected to the bus 304. An input unit 306, an output unit 307, a storage unit 308, a communication unit 309, and a drive 310 are connected to the input/output interface 305.

The input unit 306 includes a keyboard, a mouse, a microphone, and the like.

The output unit 307 includes a display, a speaker, and the like. The storage unit 308 is a hard disk, non-volatile memory, or the like. The communication unit 309 is a network interface or the like. The drive 310 drives a removable medium 311 such as a magnetic disk, an optical disc, a magneto-optical disk, or semiconductor memory.

In the computer configured as described above, for example, the CPU 301 loads a program stored in the storage unit 308 into the RAM 303 via the input/output interface 305 and the bus 304 and executes the program, so that the above-described series of processing is performed.

The program executed by the computer (the CPU 301) can be recorded on, for example, the removable medium 311 serving as a package medium for supply.

The program can also be provided via a wired or wireless transmission medium such as a local area network, the Internet, or digital satellite broadcasting.

In the computer, by mounting the removable medium 311 on the drive 310, it is possible to install the program in the storage unit 308 via the input/output interface 305. The program can be received by the communication unit 309 via a wired or wireless transmission medium to be installed in the storage unit 308. In addition, the program may be installed in advance in the ROM 302 or the storage unit 308.

The program executed by a computer may be a program that performs processing chronologically in the order described in the present specification or may be a program that performs processing in parallel or at a necessary timing such as a called time.

Embodiments of the present disclosure are not limited to the above-described embodiments, and various modifications can be made without departing from the essential spirit of the present disclosure.

The advantageous effects described herein are merely exemplary and are not limited, and other advantageous effects may be obtained.

Furthermore, the technology according to the present disclosure can be configured as follows.

### 1

An information processing method including:
performing, based on sensing information acquired in a moving body, processing of detecting a defective subject that may degrade a performance of three-dimensional modeling of a subject of interest using images shot from a plurality of viewpoints; and
outputting, when the defective subject is detected, video shooting plan information for video shooting to reduce a region of the defective subject included in the shot images.

### 2

The information processing method according to (1), wherein the video shooting plan information includes a pathway of the moving body, a position and orientation of the moving body, and an orientation of a camera included in the moving body.

### 3

The information processing method according to (2), wherein, when the defective subject is detected, the video shooting plan information in which at least one of the position and orientation of the moving body and the orientation of the camera has been corrected is output.

### 4

The information processing method according to (3), including correcting at least one of the position and orientation of the moving body and the orientation of the camera so that the subject of interest is included within an angle of view of the shot image, and the defective subject is hidden by the subject of interest in the shot image or the defective subject is excluded from the angle of view of the shot image.

### 5

The information processing method according to (3) or (4), wherein
the processing of detecting the defective subject is performed each time the shot image is shot, and
the video shooting plan information is output each time the defective subject is detected.

### 6

The information processing method according to (3) or (4), wherein
the processing of detecting the defective subject is performed based on the shot images from the plurality of viewpoints obtained by executing video shooting a plurality of times based on the video shooting plan information, and
the information processing method includes generating, when the defective subject is detected from any of the shot images from the plurality of viewpoints, the video shooting plan information for re-shooting the shot image in which the defective subject has been detected.

### 7

The information processing method according to any one of (3) to (6), including:
reflecting, when the defective subject is detected, evaluation information regarding a possibility that the defective subject will degrade the performance of the three-dimensional modeling in a map for setting a pathway of the moving body; and
generating the video shooting plan information based on the map in which the evaluation information has been reflected.

### 8

The information processing method according to (7), wherein, when the detected defective subject cannot be excluded from the shot image, the evaluation information is reflected in the map.

### 9

The information processing method according to (7) or (8), wherein the evaluation information includes information that indicates a position of the moving body at a time when the shot image in which the defective subject is detected was shot.

### 10

The information processing method according to any one of (1) to (9), including performing, after executing video shooting a plurality of times based on the video shooting plan information, three-dimensional modeling of the subject of interest using the shot images from the plurality of viewpoints.

### 11

The information processing method according to any one of (1) to (9), including performing three-dimensional modeling of the subject of interest using the shot images in parallel with executing video shooting a plurality of times based on the video shooting plan information.

### 12

The information processing method according to any one of (1) to (11), wherein the processing of detecting the defective subject is performed based on attribute information of an object obtained by semantics estimation using the sensing information.

### 13

The information processing method according to any one of (1) to (11), wherein the processing of detecting the defective subject is performed based on movement information of an object obtained by optical flow estimation using the sensing information.

### 14

The information processing method according to any one of (1) to (11), wherein the processing of detecting the defective subject is performed based on a surface shape of an object obtained by shape recognition using the sensing information.

### 15

The information processing method according to any one of (1) to (11), wherein the processing of detecting the defective subject is performed based on normal information of an object surface obtained by calculating a surface normal using the sensing information.

### 16

The information processing method according to any one of (1) to (11), wherein the processing of detecting the defective subject is performed based on texture information of an object obtained by pattern matching using the sensing information.

### 17

The information processing method according to any one of (1) to (11), wherein the processing of detecting the defective subject is performed with at least one of a blown out highlight and a crushed shadow included in the sensing information as the defective subject.

### 18

The information processing method according to any one of (1) to (17), wherein the sensing information includes at least one of an RGB image, a polarized image, and an estimated self-position of the moving body.

### 19

An information processing device including:
a subject detection unit that performs, based on sensing information acquired in a moving body, processing of detecting a defective subject that may degrade a performance of three-dimensional modeling of a subject of interest using images shot from a plurality of viewpoints; and
a video shooting planning unit that outputs, when the defective subject is detected, video shooting plan information for video shooting to reduce a region of the defective subject included in the shot images.

### 20

A program for causing a computer to execute processing of:
performing, based on sensing information acquired in a moving body, processing of detecting a defective subject that may degrade a performance of three-dimensional modeling of a subject of interest using images shot from a plurality of viewpoints; and
outputting, when the defective subject is detected, video shooting plan information for video shooting to reduce a region of the defective subject included in the shot images.

### REFERENCE SIGNS LIST

10 Moving body
11 Control unit
12 Communication unit
13 Sensor
14 Video shooting unit
15 Drive unit
30 Information processing device
31 Control unit
32 Communication unit
33 Display unit
34 Storage unit
111 Sensing information acquisition unit
112 Subject detection unit
113 Video shooting planning unit
114 Video shooting control unit
115 Shot image holding unit
116 Modeling unit
121 Video re-shooting execution determination unit
131 Map creation unit
141 Correction unit

1. An information processing method comprising:
performing, based on sensing information acquired in a moving body, processing of detecting a defective subject that may degrade a performance of three-dimensional modeling of a subject of interest using images shot from a plurality of viewpoints; and
outputting, when the defective subject is detected, video shooting plan information for video shooting to reduce a region of the defective subject included in the shot images.

2. The information processing method according to claim 1, wherein the video shooting plan information includes a pathway of the moving body, a position and orientation of the moving body, and an orientation of a camera included in the moving body.

3. The information processing method according to claim 2, wherein, when the defective subject is detected, the video shooting plan information in which at least one of the position and orientation of the moving body and the orientation of the camera has been corrected is output.

4. The information processing method according to claim 3, comprising correcting at least one of the position and orientation of the moving body and the orientation of the camera so that the subject of interest is included within an angle of view of the shot image, and the defective subject is hidden by the subject of interest in the shot image or the defective subject is excluded from the angle of view of the shot image.

5. The information processing method according to claim 3, wherein
the processing of detecting the defective subject is performed each time the shot image is shot, and
the video shooting plan information is output each time the defective subject is detected.

6. The information processing method according to claim 3, wherein
the processing of detecting the defective subject is performed based on the shot images from the plurality of viewpoints obtained by executing video shooting a plurality of times based on the video shooting plan information, and
the information processing method comprises generating, when the defective subject is detected from any of the shot images from the plurality of viewpoints, the video shooting plan information for re-shooting the shot image in which the defective subject has been detected.

7. The information processing method according to claim 3, comprising:
reflecting, when the defective subject is detected, evaluation information regarding a possibility that the defective subject will degrade the performance of the three-dimensional modeling in a map for setting a pathway of the moving body; and
generating the video shooting plan information based on the map in which the evaluation information has been reflected.

8. The information processing method according to claim 7, wherein, when the detected defective subject cannot be excluded from the shot image, the evaluation information is reflected in the map.

9. The information processing method according to claim 7, wherein the evaluation information includes information that indicates a position of the moving body at a time when the shot image in which the defective subject is detected was shot.

10. The information processing method according to claim 1, comprising performing, after executing video shooting a plurality of times based on the video shooting plan information, three-dimensional modeling of the subject of interest using the shot images from the plurality of viewpoints.

11. The information processing method according to claim 1, comprising performing three-dimensional modeling of the subject of interest using the shot images in parallel with executing video shooting a plurality of times based on the video shooting plan information.

12. The information processing method according to claim 1, wherein the processing of detecting the defective subject is performed based on attribute information of an object obtained by semantics estimation using the sensing information.

13. The information processing method according to claim 1, wherein the processing of detecting the defective subject is performed based on movement information of an object obtained by optical flow estimation using the sensing information.

14. The information processing method according to claim 1, wherein the processing of detecting the defective subject is performed based on a surface shape of an object obtained by shape recognition using the sensing information.

15. The information processing method according to claim 1, wherein the processing of detecting the defective subject is performed based on normal information of an object surface obtained by calculating a surface normal using the sensing information.

16. The information processing method according to claim 1, wherein the processing of detecting the defective subject is performed based on texture information of an object obtained by pattern matching using the sensing information.

17. The information processing method according to claim 1, wherein the processing of detecting the defective subject is performed with at least one of a blown-out highlight and a crushed shadow included in the sensing information as the defective subject.

18. The information processing method according to claim 1, wherein the sensing information includes at least one of an RGB image, a polarized image, and an estimated self-position of the moving body.

19. An information processing device comprising:
a subject detection unit that performs, based on sensing information acquired in a moving body, processing of detecting a defective subject that may degrade a performance of three-dimensional modeling of a subject of interest using images shot from a plurality of viewpoints; and
a video shooting planning unit that outputs, when the defective subject is detected, video shooting plan information for video shooting to reduce a region of the defective subject included in the shot images.

20. A program for causing a computer to execute processing of:
performing, based on sensing information acquired in a moving body, processing of detecting a defective subject that may degrade a performance of three-dimensional modeling of a subject of interest using images shot from a plurality of viewpoints; and
outputting, when the defective subject is detected, video shooting plan information for video shooting to reduce a region of the defective subject included in the shot images.
